(19) United States
(12) Patent Application Publication
(10) Pub. No.: US 2025/0231732 A1
(43) Pub. Date: Jul. 17, 2025

(54) Coupled variable exponent averaging dynamic range controllers

(71) Applicant: George Yellott Massenburg, III, Franklin, TN (US)

(72) Inventor: George Yellott Massenburg, III, Franklin, TN (US)

(21) Appl. No.: 18/896,977

(22) Filed: Sep. 26, 2024

Related U.S. Application Data
(60) Provisional application No. 63/540,487, filed on Sep. 26, 2023.

(51) Int. Cl. G06F 3/16

(52) U.S. Cl. CPC G06F 3/165

(57) ABSTRACT

A method for controlling loudness of an input signal to produce a reduced dynamic range output signal utilizing two or more exponent averaging dynamic range controllers. Each exponent averaging dynamic range controller utilizes an input signal converted to the logarithmic domain, adds an output value of the controller via a first feedback loop to the log-domain signal to produce a hybrid-domain signal, multiplies the hybrid-domain signal by an exponent value and applies an antilogarithm to produce the exponentiated output signal. Furthermore, exponent averaging dynamic range controller includes a second feedback loop with a time step delay unit at the output to produce integration of the output signal. According to a preferred embodiment, an exponent value of a first exponent averaging dynamic range controller is between 1.4 and 2.4, and an exponent value of a second exponent averaging dynamic range controller is between 2.6 and 3.6. The two output signals are combined to produce a composite loudness control signal, the composite loudness control signal being utilized to control an output loudness of the reduced dynamic range output signal.

### RELATED APPLICATIONS

The present non-provisional application is based on and claims priority to provisional patent application Ser. No. 63/540,487 by George Yellott Massenburg filed Sep. 26, 2023 for “Coupled variable exponent averaging dynamic range controllers.”

### FIELD OF THE INVENTION

The present invention is related to audio processing systems, and more particularly to systems for measuring, monitoring or controlling the perceived loudness of an audio signal.

### BACKGROUND OF THE INVENTION

Modern digital sound technologies provide an extremely wide dynamic range. It is therefore desirable to be able to provide an accurate measure of subjective loudness level and accurate methods for controlling subjective loudness. Hence, considerable effort has been devoted to the understanding of how loudness is perceived, the development of industry standards for the measurement of subjective loudness (which in the remainder of the present specification will be referred to simply as “loudness”), and the development of dynamic level control devices to compress the range subjective loudness of audio signals.

The International Telecommunication Union Radiocommunication Section issued Recommendation ITU-R BS.1770-5 in November 2023 entitled Algorithms to measure audio programme loudness and true-peak audio level (the “ITU Recommendation”). The ITU Recommendation notes that “it is essential to have a single recommended algorithm for the objective estimation of subjective loudness.” Annex 1 provides an algorithm to be used for programs of up to five channels, Annex 3 provides an algorithm to be used for programs of more than five channels, and Annex 4 provides an algorithm to be used for object-based audio signals and hybrid channel- and object-based audio signals. The algorithms of Annexes 1, 3 and 4 are similar in that they each utilize preliminary K-frequency weighting and calculate intensity as a sum of squares of instantaneous waveform (as per the standard physics definition of intensity of a wave). K-frequency weighting is a two-stage frequency filtering intended to reflect human auditory sensitivity as a function of frequency and the acoustic effect of the shape of the human head on incoming sound.

It is understood that these algorithms are only approximate measures of subjective loudness and the ITU Recommendation notes “consideration should be given to the possible need to update this Recommendation in the event that new loudness algorithms are shown to provide performance that is significantly improved over the algorithm[s]” specified therein. Most notably, the algorithms of Annexes 1, 3 and 4 of the ITU Recommendation fail to deal well with estimating the loudness of time-varying sounds, such as the transients of notes generated by musical instruments.

Loudness of tone pulses in a free field by T. Poulsen [J. Acoust. Soc. Am., Vol. 69(6), 1786 (1981)] investigates an effect known as “temporal integration of loudness” where the loudness of a steplike signal grows with time until reaching a steady-state value. Poulsen postulates a “temporal integration” model given by

$$\frac{{I}_{t}}{{I}_{∞}} = 1 / ( 1 - {e}^{- t / τ} ) , \qquad ( 1 )$$

where the left side of the equation is the ratio of intensities I that provide equal loudness for pulses of length t and infinite length. In the small time limit, the inverse of the ratio of intensities is linear in t reflecting that loudness is perceived as the integral of intensity over time. Since the time integral of intensity over time is absorbed energy, this might be a physiological effect. Poulson presents data for sinusoid pulses of frequencies 500 Hz, 1000 Hz, and 4000 Hz, and finds that a better match to the data can be achieved by adding a second factor to the equation with a second time scale to the temporal integration equation.

Comparison of loudness models of time-varying sounds by Rennies et al. [Acta Acustica united with Acustica, Vol. 96, 383-396 (2010)] compares two loudness models designed for time-varying sounds: Glasberg and Moore [J. Acoust. Soc. Am., Vol. 50, 331-341 (2002)] and Chalupper and Fastl [Acta Acustica united with Acustica, Vol. 88, 378-386 (2002)]. These papers attempt to model what is known as “temporal integration of loudness.”

It should be noted that the ITU Recommendation industry standard and the papers of Poulsen and Rennies use models where the parameters of interest are intensity and frequency, either as determined by Fourier analysis or in the use of sinusoidal waveforms. In contrast, the present invention provides dynamic range control by estimating loudness utilizing what will be referred to herein as “generalized intensities” where the time domain, rather than the frequency domain, is the natural variable.

According to the present invention, a generalized intensity is a nth-root mean nth-power value. The circuit of the present invention produces generalized intensities via a feedback circuit with a time-step delay which functions as an integrator, where the input to the feedback loop is a logarithm of the input signal. Within the loop, the logarithmed input signal is multiplied by an exponent value and then anti-logged and sent (generally with further processing) to a summer at the input of the loop, thus producing a time-weighted sum of exponentiated values as the output of the loop. In a special case where the exponent value of the generalized intensity is two, the output of the feedback loop is a time integration of the standard physics definition of intensity, corresponding to the small-time limit of the temporal integration equation of Poulsen.

According to a preferred embodiment of the present invention, loudness estimation and dynamic range control is derived from a first integration of a first generalized intensity produced by a first feedback loop, and a second integration of a second generalized intensity produced by a second feedback loop.

### SUMMARY OF THE INVENTION

A method for detecting a loudness of an input signal to produce a reduced dynamic range output signal comprising the steps of a first exponentiation of an input string of input samples derived from the input signal to a first exponent, the first exponent having a first exponent value within a first exponent range between 1.4 and 2.4, to produce first-exponentiated samples, generating a first series of first weighted sums of the first-exponentiated samples to generate a first loudness control signal, second exponentiation of the input string of input samples derived from the input signal to a second exponent, the second exponent having a second exponent value within a second exponent range between 2.6 and 3.6, to produce a third series of second-exponentiated samples, generating a second series of second weighted sums of the second-exponentiated samples to generate a second loudness control signal, and combining the first loudness control signal and the second loudness control signal to produce a composite loudness control signal, the composite loudness control signal being utilized to control an output loudness of the reduced dynamic range output signal.

A method for processing an input signal to produce a reduced dynamic range output signal comprising the steps of a first exponentiation of an input string of input samples of the input signal to a first exponent, the first exponent having a first exponent value selectable by a user to produce first-exponentiated samples, generating a first series of first weighted sums of said first-exponentiated samples to generate a first loudness control signal, second exponentiation of the input string of the input samples of the input signal to a second exponent, the second exponent having a second exponent value selectable by a user to produce second-exponentiated samples, generating a second series of second weighted sums of the second-exponentiated samples to generate a second loudness control signal, combining the first loudness control signal and the second loudness control factor signal to produce a composite loudness control signal, the composite loudness control signal being utilized to control an output loudness of the dynamic range reduced output signal.

### BRIEF DESCRIPTION OF THE DRAWINGS

FIG. 1 shows a circuit according to a preferred embodiment of the present invention which incorporates two variable exponent averaging circuits.

FIG. 2 shows the variable exponent averaging circuit portion of the circuit of FIG. 1 according to a preferred embodiment of the present invention.

FIG. 3 shows the release override circuit portion of the circuit of FIG. 1 according to a preferred embodiment of the present invention.

FIG. 4 shows a graphical user interface for the circuit of FIG. 1.

FIG. 5A shows a knee function with a “hard” knee used by the peak hard/soft transition unit of the system of the present invention.

FIG. 5B shows a knee function used by a peak hard/soft transition unit of the system of the present invention with a softer knee than that of the knee function of FIG. 5A.

FIG. 5C shows a knee function used by a peak hard/soft transition unit of the system of the present invention with a softer knee than that of the knee function of FIG. 5B.

### DETAILED DESCRIPTION OF THE PREFERRED EMBODIMENT

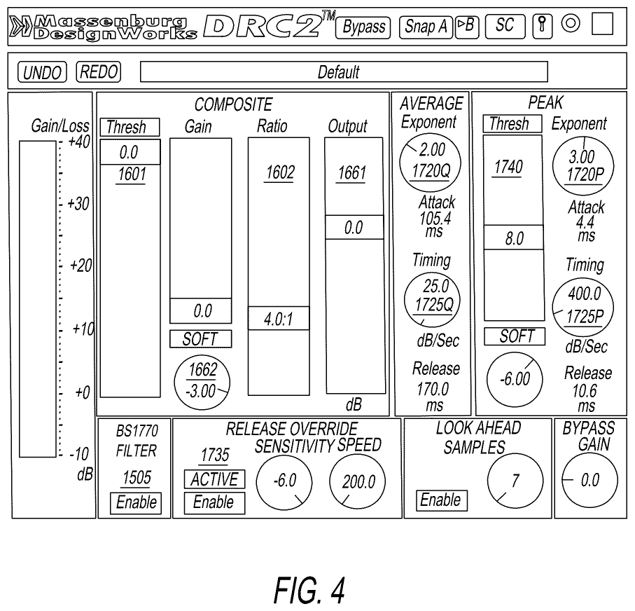

FIG. 4 shows a graphical user interface (1700) for the system of dynamic range control of the present invention. The interface (1700) has multiple panels (1701), (1702), (1703), (1704) and (1705), each panel corresponding to a portion of the processing and control of the dynamic range control system on the present invention. The interface (1700) has an average control panel (1701), a peak control panel (1702), a release override control panel (1703), a composite control panel (1704), and a BS 1770 filter control panel (1705). The average control panel (1701) has an average exponent value control knob (1720Q) and an average timing control knob (1725Q). Similarly, the peak control panel (1702) has a peak exponent value control knob (1720P) and a peak timing control knob (1725P). In the peak control panel (1702) is also a threshold control slider (1740) and a soft control knob (1742). The release override control panel (1703) has a release override speed control knob (1730), release override sensitivity control knob (1732), and a release override enable button (1735). (It should be noted that while some controls are shown as knobs and some are shown as sliders in the user interface (1700) of FIG. 4, the present invention is not to be considered limited by their particular geometry/form shown in FIG. 4). Within the composite control panel (1704) is a composite threshold control slider (1601), a composite ratio control slider (1602), a composite gain control slider (1603), an composite output control slider (1661), and a composite soft control knob (1662). The BS 1770 filter control panel (1705) has a BS 1770 filter engage button (1735).

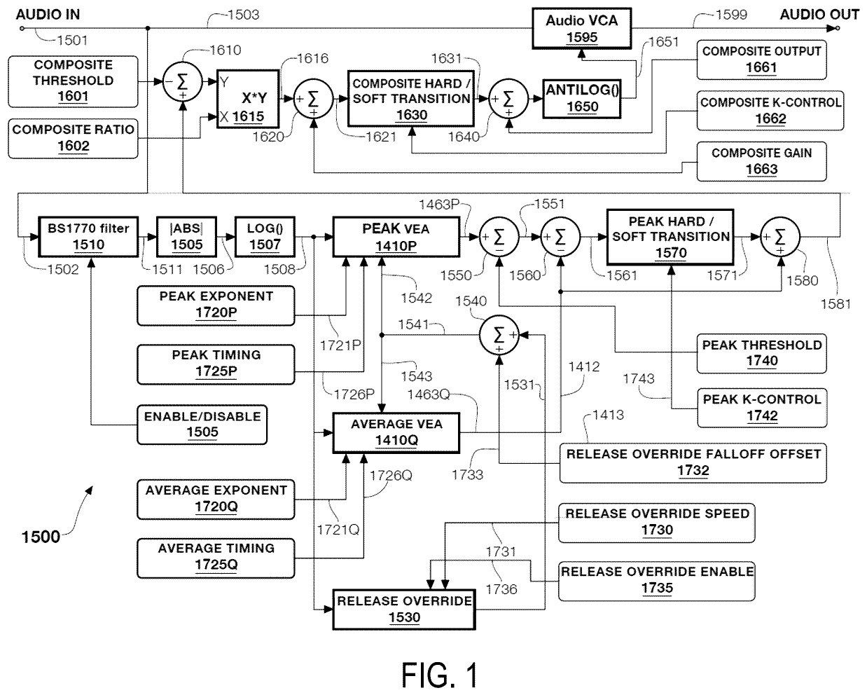

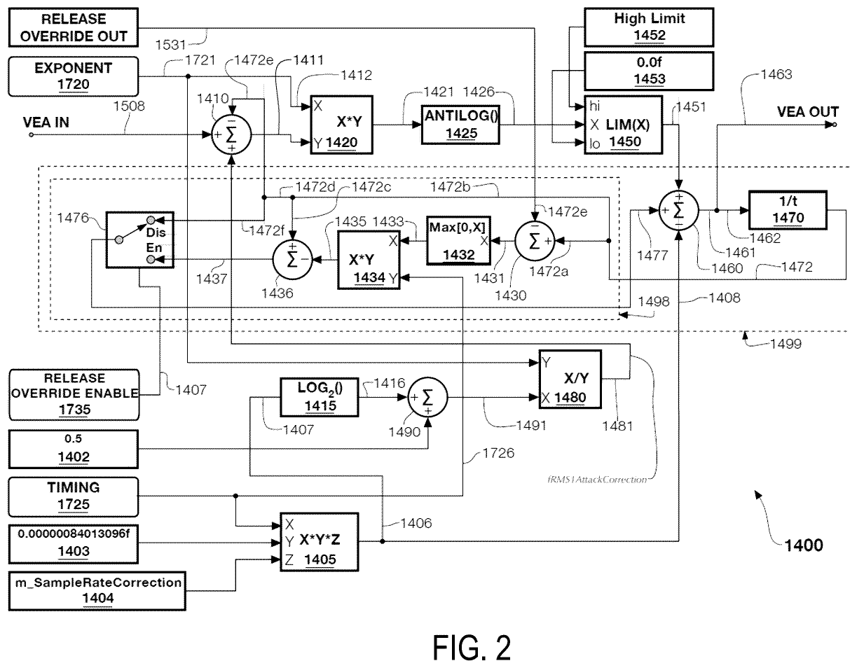

The heart of the present invention is the variable exponent averaging (VEA) circuit (1400) shown in FIG. 2. According to the present invention at least two variable exponent averaging circuits (1400) are utilized to provide a system for dynamic range control that has a highly natural sound since the algorithm utilized by a VEA circuit (1400), and more so the combination of VEA circuits (1400) as per FIG. 1, effectively mimics the processing performed in human perception of audio, and particularly the perception of loudness. The dynamic range monitoring and control processing of the present invention is highly transparent and free of processing artifacts, even when imposing considerable dynamic range adjustments on a signal.

As shown in FIG. 1, according to a preferred embodiment of the present invention a peak VEA (1400P) and an average VEA (1400Q) are utilized. The peak VEA (1400P) and the average VEA (1400Q) circuits are both the VEA circuit (1400) shown in FIG. 2—their reference numerals 1400P and 1400Q differ in the appended final letter to indicate that the circuits (1400P) and (1400Q) are located at different locations in the circuit (1500) of FIG. 1 and have different input control values.

As shown in FIG. 2, input controls to a VEA circuit (1400) include an exponent value (1721), a timing value (1726), and a release override value (1541). The peak exponent control knob (1720P) provides the peak exponent value (1721P) to the peak VEA (1400P), the average exponent control knob (1720Q) provides the average exponent value (1721Q) to the average VEA (1400Q), the peak timing control knob (1725P) provides the peak timing value (1726P) to the peak VEA (1400P), and the average timing control knob (1725Q) provides the average timing value (1726Q) to the average VEA (1400Q). As shown in FIG. 1, the same release override value (1541) is directed to the peak VEA (1400P) and the average VEA (1400Q). For consistency, the release override value directed to the peak VEA (1400P) is labeled with reference numeral 1541P, and the release override value directed to the average VEA (1400Q) is labeled with reference numeral 1541Q.

As shown in FIG. 1, the audio input (1501) to the system is first directed to a BS 1770 filter (1510). As is well-known in the art of sound processing, BS 1770 filtering applies what is known as the K-weighting filter to compensate for the varying sensitivity of the human auditory system to sound as a function of frequency, giving more emphasis to the frequencies which the human auditory system is less sensitive to. The specifications for the BS 1770 standards are incorporated herein by reference. The output (1511) of the BS 1770 filter (1510) is fed to an absolute value unit (1505) which provides an output signal (1506) which is the absolute value of the input signal (1511), i.e., it provides an output signal (1506) which is a full-wave rectified version of the input signal (1511). The unique characteristics of the system of the present invention are then initiated by a logarithm unit (1507) which takes the logarithm of the output (1506) of the absolute value unit (1505) to produce a logarithmed signal (1508) which is directed to the peak VEA (1400P) and the average VEA (1400Q). While the logarithm unit (1507) is shown as exterior to the VEA circuits (1400P) and (1400Q) since the same logarithmed signal (1508) is fed to both the peak VEA (1400P) and the average VEA (1400Q), it is to be understood that the taking of a logarithm is integral to the process of variable exponent averaging according to the present invention and so, conceptually, the logarithm unit (1507) should be considered part of the VEAs (1400P) and (1400Q).

The user may set the peak exponent value (1721P) and average exponent value (1721Q) utilizing the peak exponent control knob (1720P) and the average exponent control knob (1720Q), respectively. As discussed below, most commonly a peak exponent value (1721P) between 2.6 and 3.6 and an average exponent value (1721Q) between 1.4 and 2.4 will be utilized. According to an alternative preferred embodiment, the peak exponent value (1721P) is between 3.6 and 4.6 and the average exponent value (1721Q) is between 1.4 and 2.4 will be utilized. Furthermore, the user utilizes the peak timing control knob (1725P) to set a peak timing value (1726P) directed to the peak VEA (1400P), and utilizes the average timing control knob (1725Q) to set a average timing value (1726Q) directed to the average VEA (1400Q).

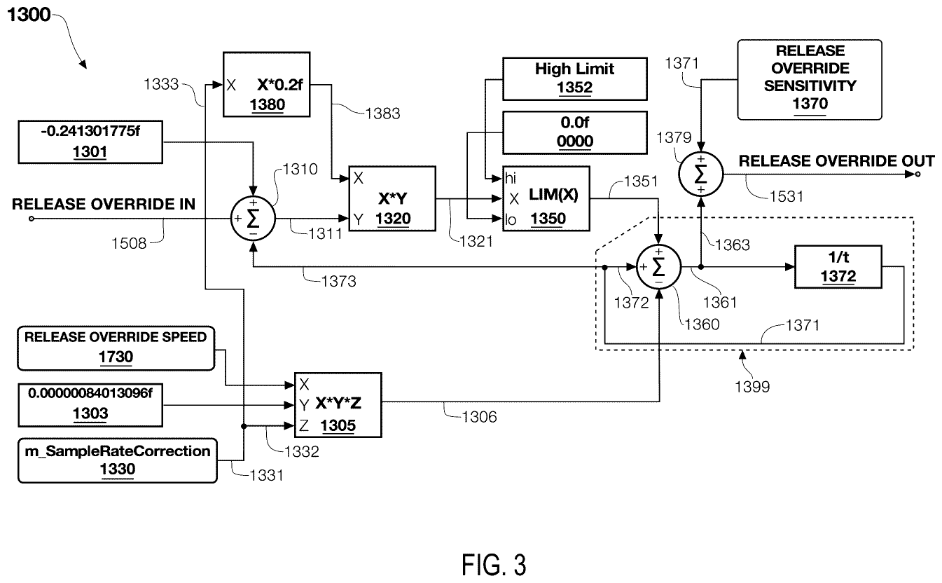

The logarithmed signal (1508) is also directed to a release override unit (1530), the circuitry of which is shown in FIG. 3 and which is discussed in detail below. Also directed to the release override unit (1530) is a release override speed value (1731) which is set by the user using the release override speed control knob (1730)/(1370). The user controls whether the release override unit (1530) is active by toggling the release override enable button (1735). When the release override enable button (1735) is toggled to inactive, the output (1531) of the release override unit (1530) is zero.

The release override output signal (1531) from the release override unit (1530) is directed to an addition port of a summer (1540). The summer (1540) also has a second addition port to which a release override falloff offset/sensitivity value (1733) is directed. The release override falloff offset/sensitivity value (1733) is controlled by the user using the release override sensitivity knob (1732). The sum (1541) produced by the summer (1540) is directed to both the peak VEA (1400P) and the average VEA (1400Q).

Broadly speaking, signals which have prominent transients, such as snare hits, will have a larger peak VEA output signal (1463P) in the transient region relative to the non-transient region than is the case with the average VEA output signal (1463Q) when the two signals (1463Q) and (1463P) are properly normalized, i.e., when the two signals (1463Q) and (1463P) are properly level adjusted relative to each other. The normalization of the two signals (1463P) and (1463Q) and their compositing is performed by compositing components (1550), (1560), (1570) and (1580) to provide dynamic range control based on a combination of the average exponent value (1721Q) and the peak exponent value (1721P). First, a threshold level (1741) selected by the user utilizing the peak threshold slider (1740) is subtracted from the peak VEA output (1463P) at summer (1550) to produce a threshold-reduced peak VEA output (1551). The average VEA output (1463Q) is then subtracted from the threshold-reduced peak VEA output (1551) to produce a VEA difference signal (1561) which reflects a difference between a peak exponent evaluation of the input signal (1501) and an average exponent evaluation of the input signal (1501).

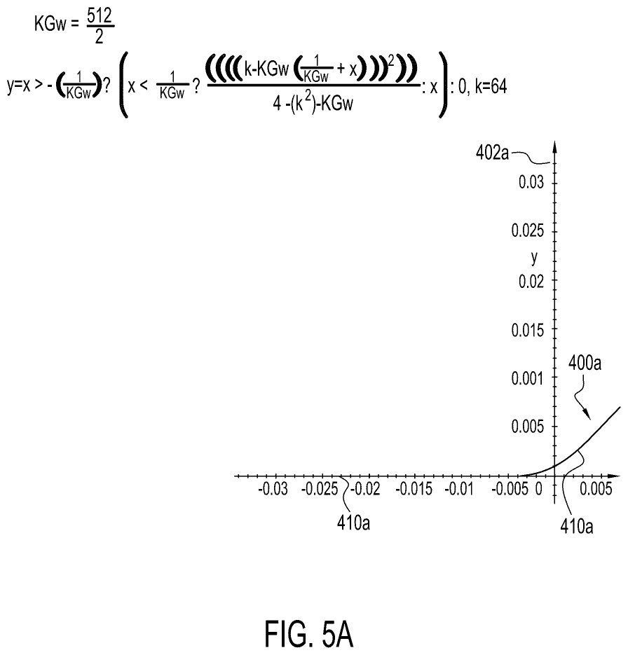

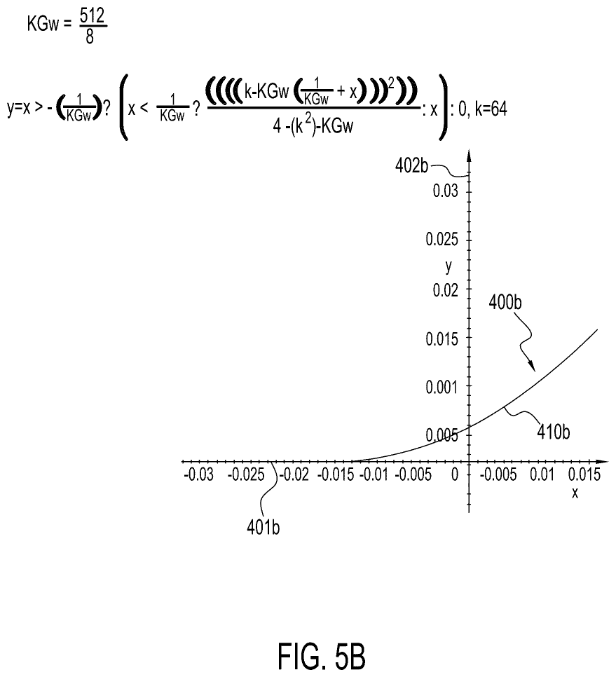

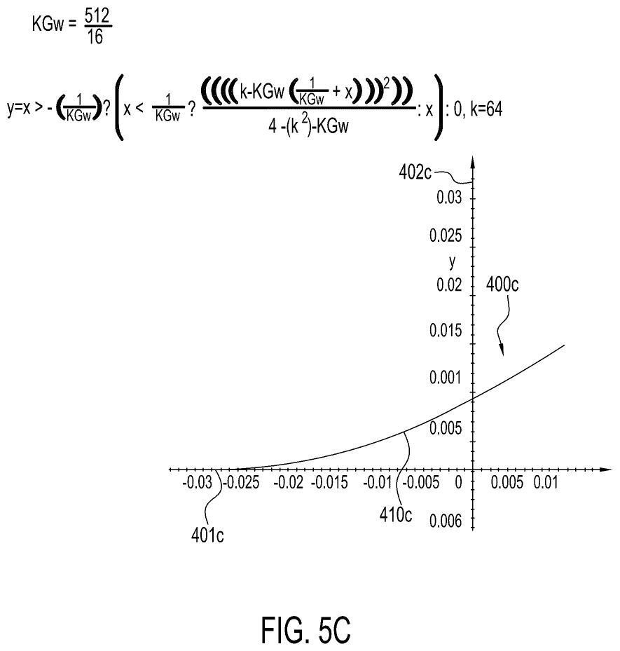

The VEA difference signal (1561) is directed to a peak hard/soft transition unit (1570) which has a peak K-control value (1743) controlled by the user utilizing the peak K-control knob (or alternatively termed the “soft” control knob) (1742). The peak hard/soft transition unit (1570) provides a mapping using a knee function, i.e., a function such as the one (400a) shown in FIG. 5A where the ordinate (402a) asymptotically approaches or equals zero for large negative values of an abscissa (401a), and the ordinate (402a) asymptotically approaches or equals the abscissa (401a) for large positive values of the abscissa (401a). The behavior of a knee function in the region of the origin determines whether the knee is “hard” or “soft.” The knee (410a) of the knee function (400a) of FIG. 5A is considered to be harder than knee (410b) of the knee function (400b) of FIG. 5B since the curvature in the knee (410a) of the function (400a) of FIG. 7A is sharper than the curvature in the knee (410b) of the function (400b) of FIG. 5B. And the knee (410b) of the knee function (400b) of FIG. 5B is considered to be harder than knee (410c) of the knee function (400c) of FIG. 5C for the same reason.

Hence, compositing components (1550), (1560), (1570) and (1580) allow the outputs (1463P) and (1463Q) of the peak VEA (1400P) and the average VEA (1400Q) to be normalized, and then the peak/hard soft transition unit (1570) determines how much of the difference signal (1561) to add to the average VEA output signal (1463Q). When the peak VEA output (1463P) is substantially larger than the average VEA output (1463Q), the entirety of the difference signal (1571) is added to the average VEA output (1463Q) to produce the composited signal (1581). When the peak VEA output (1463P) is substantially less than the average VEA output (1463Q), nothing is added to the average VEA output (1463Q) to produce the composited signal (1581). And when the difference signal (1561) is of a magnitude such that it falls in the knee region (410), the peak K-control value (1743) determined by the peak K-control knob (1742) determines how much of the difference signal (1571) is added to the average VEA output (1463Q) to produce the composited signal (1581).

The output (1581) of summer (1580) is directed to an addition input of summer (1610). The summer (1580) has a subtraction input into which is directed a composite threshold value (1603) determined by the user using the composite threshold slider (1601). The output of summer (1610) is directed to an X*Y multiplier (1615) as the Y input, and the X input to the X*Y multiplier (1615) is a composite ratio value (1604) determined by the user using the composite ratio slider (1602). The output (1616) of the multiplier (1615) is directed to an addition input of a summer (1620), and a composite gain value (1664) determined by the user using the composite gain slider (1663) is directed to a subtraction input of the summer (1620). The output (1621) of the summer (1620) is directed to a composite hard/soft transition unit (1630). The composite hard/soft transition unit (1630) applies a knee function to the input (1621) in the same manner which the peak hard/soft transition unit (1570) applies a knee function to the input (1561) as described in detail above. I.e., the composite K-control knob (1662) controls the sharpness of the knee of the composite hard/soft transition unit (1630) in the same manner as the peak K-control knob (1742) controls the sharpness of the knee of the composite hard/soft transition unit (1570). The output of the composite hard/soft transition unit (1630) is directed to an addition input of summer (1640) and the composite gain value (1664) determined by the user setting of the composite gain slider (1663) is directed to a second addition input of the summer (1640). In addition, a composite output value (1659) determined by the user's setting of the composite output slider (1661) is directed to a subtraction input of the summer (1640). It should be noted that while the functionalities and interconnections of components (1620), (1630), (1640), (1662) and (1663) parallels the functionalities and interconnections of components (1560), (1570), (1580), (1742) and (1400Q), component (1663) is termed a “gain” and is a user controlled value while component (1400Q) produces a time varying signal which reflects a root-mean-square value of the audio signal input (1501). The output of the summer (1640) is negated (i.e., sign switched) by component (1641) and the antilogarithm of the negated signal is sent to antilog unit (1650). The output of the antilog unit (1650) is the level control signal (1651) sent to the audio VCA (1595). I.e., the degree of loudness control applied to the input audio signal (1501) is determined by the level control signal (1651) which is derived from the processing of the circuit (1500) of FIG. 1 and applied at the audio VCA (1595) to produce the audio output signal (1599).

As discussed above, the processing of the peak VEA (1400P) and the average VEA (1400Q) is performed by the VEA circuitry (1400) shown in FIG. 2. As discussed above with regards to FIG. 1, both the peak VEA (1400P) and the average VEA (1400Q) are both fed signal (1508), which is the output of the log unit (1507), but they receive different exponent values (1721P) and (1721Q). The peak exponent control knob (1720P) controls the peak exponent value (1721P) directed to the peak VEA (1400P), and similarly the average exponent control knob (1720Q) controls the average exponent value (1721Q) directed to the average VEA (1400Q). The VEA input (1508) is first directed to the addition input of a summer (1410). The summer (1410) also has a second addition input into which is directed a logarithmed release override signal (1481). Furthermore, summer (1410) also has a subtraction input into which is directed a time-delayed feedback signal (1472e). (It should be noted that in FIG. 2 portions of the time-delayed feedback signal path (1472) are labelled with reference numerals having the same first four numerical digits, but differing with an appended final letter. It should be understood that the signal value at any moment anywhere along time-delayed feedback signal path (1472) is the same and the appended letters are utilized merely for purposes of explanation with regards to bifurcations of the path (1472).) The output (1411) of summer (1410) is directed into the Y input of an X*Y multiplier (1420) and the exponent value (1721) is directed into the X input of the X*Y multiplier (1420). The X*Y output (1421) of the X*Y multiplier (1420) is directed to an antilog unit (1425), which produces as an antilogged output (1426) the antilog of the input value (1421) to the unit (1425). The antilogged output (1426) is directed to a limiter (1450) which has a high limit value (1426) and a low limit value (1453) of zero. It is important to provide a high limit because exponentiation, i.e., antilogging, can produce very large output values (1426). The output of the limiter (1450) is directed to an integrator (1499) which includes the components within the dashed line indicated by the arrowhead. The integrator (1499) includes an integrator summer (1460), a 1/t delay unit (1470), and a feedback path (1498). The feedback path (1498) includes all the components within the dashed line indicated by the arrowhead. In particular, the output of the limiter (1450) is directed to an addition input of the integrator summer (1460). An unlogarithmed release override value (1408) is directed into an subtraction input of the summer (1460), and a return feedback path signal (1477) is directed into another addition input of the summer (1460). The output of the summer (1460) is directed to the 1/t delay unit (1470). The 1/t delay unit (1470) produces a one time-step delay to the output signal (1472), which is the outgoing feedback path signal (1472).

Release override enable switch (1735) controls switching (1476) within the feedback path (1498). When the release override enable switch (1735) is toggled to disable, switching (1476) provides a direct route from the outgoing feedback path signal (1472) which is the output of the 1/t delay unit (1470) to the addition input of the summer (1460). It should be noted that, as discussed above, the outgoing feedback path signal (1472) is also directed into the addition input of the initial summer (1410) regardless of the toggle position of the release override enable switch (1735). When the release override enable switch (1735) is in the enable mode, the summer (1430), Max[0,X] unit (1432), X*Y multiplier (1434), and summer (1436) are forced into the signal path. In particular, the outgoing feedback path signal (1472) is directed to the addition input of summer (1430) and the release override output value (1541) is directed to the subtraction input of the summer (1430), producing a difference signal (1431) which is directed into a Max[0,X] unit (1432). The Max[0,X] unit (1432) produces an output value (1433) which is the maximum of the difference signal (1431) and zero, i.e., the Max[0,X] unit (1432) insures that the output value (1433) is always positive. The output (1433) of the Max[0,X] unit (1432) is directed to the X input of an X*Y multiplier (1434), and the timing value (1726) as controlled by the timing knob (1725) is directed to the Y input of the X*Y multiplier (1434). The output (1435) of the X*Y multiplier (1434) is directed to a subtraction input of a second summer (1436) in the feedback path (1498), while the unaltered outgoing feedback path value (1472c) is directed to the addition input of the second summer (1436). The output of the summer (1436) is sent to the enable input of the switching (1476) controlled by the release override enable switch (1735), and when the release override enable switch (1735) is toggled to the enable position the output of the switching (1476) is directed to an addition input of the integrator summer (1460).

As noted above, each VEA (1400P) and (1400Q) in the circuit (1500) of FIG. 1 has its own timing value (1726P) and (1726Q), the timing values (1726P) and (1726Q) being controlled by the user via timing exponent knobs (1720P) and (1720Q) on the control panel (1700). It should be noted that although the timing values (1726P) and (1726Q) are depicted in FIG. 1 as being a single input to the VEA (1400P) and (1400Q), respectively, the timing value (1726) is utilized in three ways in the VEA circuit (1400). Firstly, as discussed above, a multiplied timing value (1408) is directed to the subtractive input of the integrator summer (1460). In particular, the timing value (1726) is directed to a X*Y*Z multiplier (1405) as the X input, a scaling factor (1403) of roughly 1×10⁻⁷ directed to the Y input, and a sample rate correction factor (1404) is directed to the Z input. The sample rate correction factor (1404) has a value of 4.0 when the sample rate is less than 5.1×10⁴ Hz, the sample rate correction factor (1404) has a value of 2.0 when the sample rate is greater than 5.1×10⁴ Hz and less than 1.02×10⁵ Hz, and the sample rate correction factor (1404) has a value of 1.0 when the sample rate is greater than 1.02×10⁵ Hz. Thirdly, the multiplied timing value (1408) is directed to a logarithm unit (1415) which takes the logarithm of the multiplied timing value (1408) to provide a logarithmed timing value (1416). The logarithmed timing value (1416) is directed to the addition input of a summer (1490), and the summer (1490) has a second addition input to which an adjustment term (1402) having a value of roughly 0.5 is directed, to produce an adjusted timing value (1491). The adjusted timing value (1491) is directed to the X input of an X/Y divider (1480), and the exponent value (1721) is directed to the Y input of the X/Y divider (1480). The output (1481) of the X/Y divider (1480) is directed to one of the addition inputs of the initial summer (1410).

In addition to the input signal (1508) being directed to the peak VEA (1400P) and the average VEA (1400Q), the input signal (1508) is directed to the input of the release override unit (1300). In a number of aspects, the circuitry of the release override unit (1300) is similar to the circuitry of VEA circuit (1400). Both have an initial summer (1310) and (1410), both have a multiplier (1320) and (1420) following the initial summer (1310) and (1410), both utilize an integrator (1399) and (1499), both incorporate a limiter (1350) and (1450) prior to the signal entering an integrator (1399) and (1499), and both have a feedback signal (1372) and (1472) from the integrator (1399) and (1499) which is directed to a subtraction input of the initial summer (1310) and (1410).

In particular, as shown in FIG. 3, the release override input (1508) is directed to the addition input of the initial summer (1310). An offset value of roughly −0.25 is directed to another addition input of the initial summer (1310), and as discussed above a feedback signal (1372) is directed to the subtraction input of the initial summer (1310). The output (1311) of the summer (1310) is directed to an X*Y multiplier (1320) as the Y input. Again, a sample rate correction factor (1331) produced by a sample rate correction factor unit (1330) has a value of 4.0 when the sample rate is less than 5.1×10⁴ Hz, the sample rate correction factor (1331) has a value of 2.0 when the sample rate is greater than 5.1×10⁴ Hz and less than 1.02×10⁵ Hz, and the sample rate correction factor (1331) has a value of 1.0 when the sample rate is greater than 1.02×10⁵ Hz. The Y input of the X*Y multiplier (1320) is the output (1311) of the initial summer (1310). However, in contrast with the VEA circuitry (1400) in the release override circuitry (1300), the X input to the X*Y multiplier (1320) is a multiple of the sample rate correction value (1331).

Thus, it will be seen that the improvements presented herein are consistent with the objects of the invention described above. While the above description contains many specificities, these should not be construed as limitations on the scope of the invention, but rather as exemplifications of preferred embodiments thereof. Many other variations are within the scope of the present invention. Accordingly, it is intended that the scope of the invention be determined not by the embodiments illustrated or the physical analyses motivating the illustrated embodiments, but rather by the claims to be included in a non-provisional application based on the present provisional application and the claims' legal equivalents.

What is claimed is:

1. A method for detecting a loudness of an input signal to produce a reduced dynamic range output signal comprising the steps of:
first exponentiation of an input string of input samples derived from said input signal to a first exponent, said first exponent having a first exponent value within a first exponent range between 1.4 and 2.4, to produce first-exponentiated samples,
generating a first series of first weighted sums of said first-exponentiated samples to generate a first loudness control signal,
second exponentiation of said input string of said input samples derived from said input signal to a second exponent, said second exponent having a second exponent value within a second exponent range between 2.6 and 3.6, to produce a third series of second-exponentiated samples,
generating a second series of second weighted sums of said second-exponentiated samples to generate a second loudness control signal, and
combining said first loudness control signal and said second loudness control signal to produce a composite loudness control signal, said composite loudness control signal being utilized to control an output loudness of said reduced dynamic range output signal.

2. The method of claim 1 wherein said first exponent value within said first exponent range is selectable by a user, and said second exponent value within said second exponent range is selectable by said user.

3. The method of claim 1 wherein said first exponent range is between 1.6 and 2.4, and said second exponent range is between 2.6 and 3.4.

4. The method of claim 1 wherein said first exponent range is between 1.8 and 2.2, and said second exponent range is between 2.8 and 3.2.

5. The method of claim 1 wherein said composite loudness control signal (1581) is applied as a multiplicative factor to said input signal to produce said reduced dynamic range output signal.

6. The method of claim 1 wherein said input signal and said reduced dynamic range output signal are audio signal waveforms and said input samples are time samples.

7. The method of claim 1 wherein said combining of said first loudness control signal and said second loudness control signal includes subtracting said first loudness control signal from said second loudness control signal to produce a loudness control difference signal, utilizing an knee-shaped augmentation function to map said loudness control difference signal to a loudness augmentation signal, and adding said loudness augmentation signal to said first loudness control signal to produce said composite loudness control signal.

8. The method of claim 7 wherein said combining of said first loudness control signal and said second loudness control signal includes an addition/subtraction operation to said second loudness control signal prior to subtracting said first loudness control signal from said second loudness control signal.

9. The method of claim 7 wherein said addition/subtraction operation to said second loudness control signal is controllable by a user.

10. The method of claim 7 wherein an ordinate of said knee-shaped augmentation function asymptotically approaches or equals zero for large negative values of an abscissa, and said ordinate asymptotically approaches or equals said abscissa for large positive values of said abscissa.

11. The method of claim 10 wherein a sharpness control factor controls a curvature κ of said knee-shaped augmentation function in an abscissa-ordinate origin region.

12. The method of claim 11 wherein said sharpness control factor is selectable by a user.

13. The method of claim 1 wherein said first exponentiation is performed by taking logarithms of absolute values of said input string of said input samples to produce a first logarithmed string of samples and multiplying said first logarithmed string of samples by said first exponent value to produce a first multiplied string of samples, and said second exponentiation is performed by taking logarithms of absolute values of said input string of said input samples to produce a second logarithmed string of samples and multiplying said second logarithmed string of samples by said second exponent value to produce a second multiplied string of samples.

14. The method of claim 13 wherein said first logarithmed string of samples is the same as said second logarithmed string of samples.

15. The method of claim 13 wherein a first antilogarithm is applied to said first multiplied string of samples to produce a first antilogarithmed string of samples and said first antilogarithmed string of samples is directed to a first time integrator to produce said first loudness control signal, and a second antilogarithm is applied to said second multiplied string of samples to produce a second antilogarithmed string of samples and said second antilogarithmed string of samples is directed to a second time integrator to produce said second loudness control signal.

16. The method of claim 15 wherein said first time integrator sends said first loudness control signal in a first feedback path back to a first integrator summer, and said second time integrator sends said second loudness control signal in a second feedback path back to a second integrator summer.

17. The method of claim 16 wherein said first feedback path includes a first one-sample time delay which produces a first sample-delayed signal from said first loudness control signal, and said second feedback path includes a second one-sample time delay which produces a second sample-delayed signal from said second loudness control signal.

18. The method of claim 17 wherein said first sample-delayed signal is added to a first addition signal derived from said first antilogarithmed string of samples at said first integrator summer to produce said first loudness control signal, and said second sample-delayed signal is added to a second addition signal derived from said second antilogarithmed string of samples at said second integrator summer to produce said second loudness control signal.

19. The method of claim 16 wherein said first antilogarithmed string of samples is directed to said first time integrator via a first limiter which insures a first upper limit to input to said first integrator, and said second antilogarithmed string of samples is directed to said second time integrator via a second limiter which insures a second upper limit to input to said second integrator.

20. The method of claim 16 wherein said first loudness control signal is utilized to produce a first subtraction signal which is subtracted from said first logarithmed string of samples, and said second loudness control signal is utilized to produce a second subtraction signal which is subtracted from said second logarithmed string of samples.

21. The method of claim 20 wherein a first timing value is utilized in a subtraction at said first integrator summer, and a second timing value is utilized in a subtraction at said second integrator summer.

22. The method of claim 21 wherein a first logarithm of said first timing value is utilized in a first addition to said first logarithmed string of samples, and a second logarithm of said second timing value is utilized in a second addition to said second logarithmed string of samples.

23. The method of claim 22 wherein said first logarithm of said first timing value utilized in said first addition to said first logarithmed string of samples is divided by said first exponent value, and said second logarithm of said second timing value utilized in said second addition to said second logarithmed string of samples is divided by said second exponent value.

24. The method of claim 17 wherein said first feedback path further includes a first release override summer which subtracts a release override signal from said first sample-delayed signal to produce a first release override reduced signal, said first release override reduced signal being limited at a first max zero-versus-signal selector to produce a first positive-valued release override reduced signal, directing said first positive-valued release override reduced signal to a subtraction input of a second release-override summer where said first sample-delayed signal is input to an addition input of said second release override summer to produce a first release override reduced sample-delayed signal, and directing said first release override reduced sample-delayed signal to an addition input of said first integrator summer to produce said first loudness control signal, and wherein said second feedback path further includes a third release override summer which subtracts said release override signal from said second sample-delayed signal to produce a second release override reduced signal, said second release override reduced signal being limited at a second max zero-versus-signal selector to produce a second positive-valued release override reduced signal, directing said second positive-valued release override reduced signal to a subtraction input of a fourth release-override summer where said second sample-delayed signal is input to an addition input of said fourth release override summer to produce a second release override reduced sample-delayed signal, and directing said second release override reduced sample-delayed signal to an addition input of said second integrator summer to produce said second loudness control signal.

25. The method of claim 24 wherein said first positive-valued release override reduced signal is utilized in a first multiplication with said first timing value prior to input to said subtraction input of said second release-override summer, and said second positive-valued release override reduced signal is utilized in a second multiplication with said second timing value prior to input to said subtraction input of said fourth release-override summer.

26. The method of claim 25 wherein said release override signal is produced by taking logarithms of absolute values of said input string of said input samples to produce a third logarithmed string of samples, and directing said third logarithmed string of samples to a third time integrator which produces said release override signal.

27. The method of claim 26 wherein said third logarithmed string of samples is the same as said first logarithmed string of samples and said second logarithmed string of samples.

28. The method of claim 26 wherein said third time integrator sends said release override signal in a third feedback path back to a third integrator summer.

29. The method of claim 28 wherein said third feedback path includes a third one-sample time delay which produces a third sample-delayed signal.

30. The method of claim 29 wherein said third sample-delayed signal is added to a third addition signal derived from said third logarithmed string of samples at said third integrator summer to produce said release override signal.

31. The method of claim 30 wherein said third sample-delayed signal is subtracted from said third logarithmed string of samples to produce a value-reduced logarithmed string of samples which is utilized to produce said third addition signal.

32. The method of claim 31 wherein said value-reduced logarithmed string of samples is directed to said third time integrator via a third limiter to insure a third upper limit to said third

33. The method of claim 31 wherein said value-reduced logarithmed string of samples is multiplied by a sample correction rate to produce a corrected value-reduced logarithmed string of samples which is directed to said third time integrator via a third limiter to insure a third upper limit to said third addition signal.

34. A method for processing an input signal to produce a reduced dynamic range output signal comprising the steps of:
first exponentiation of an input string of input samples of said input signal to a first exponent, said first exponent having a first exponent value selectable by a user to produce first-exponentiated samples,
generating a first series of first weighted sums of said first-exponentiated samples to generate a first loudness control signal,
second exponentiation of said input string of said input samples of said input signal to a second exponent, said second exponent having a second exponent value selectable by a user to produce second-exponentiated samples,
generating a second series of second weighted sums of said second-exponentiated samples to generate a second loudness control signal,
combining said first loudness control signal and said second loudness control factor signal to produce a composite loudness control signal, said composite loudness control signal being utilized to control an output loudness of said dynamic range reduced output signal.

35. The method of claim 34 wherein said composite loudness control signal is applied as a multiplicative factor to said input signal to produce said dynamic range reduced output signal.

36. The method of claim 34 wherein said input signal and said dynamic range reduced output signal (1599) are audio signal waveforms and said input samples are time samples.

37. The method of claim 34 wherein said combining of said first loudness control signal and said second loudness control signal includes subtracting said first loudness control signal from said second loudness control signal to produce a loudness control difference signal, utilizing an knee-shaped augmentation function to map said loudness control difference signal to a loudness augmentation signal, and adding said loudness augmentation signal to said first loudness control signal to produce said composite loudness control signal.

38. The method of claim 37 wherein an ordinate of said knee-shaped augmentation function asymptotically approaches or equals zero for large negative values of an abscissa, and said ordinate asymptotically approaches or equals said abscissa for large positive values of said abscissa.

39. The method of claim 38 wherein a sharpness control factor controls a curvature κ of said knee-shaped augmentation function in an abscissa-ordinate origin region.

40. The method of claim 39 wherein said sharpness control factor is selectable by a user.

41. The method of claim 34 wherein said first exponentiation is performed by taking logarithms of absolute values of said input string of said input samples to produce a first logarithmed string of samples and multiplying said first logarithmed string of samples by said first exponent value to produce a first multiplied string of samples, and said second exponentiation is performed by taking logarithms of absolute values of said input string of said input samples to produce a second logarithmed string of samples and multiplying said second logarithmed string of samples by said second exponent value to produce a second multiplied string of samples.

42. The method of claim 41 wherein said first logarithmed string of samples is the same as said second logarithmed string of samples.

43. The method of claim 41 wherein a first antilogarithm is applied to said first multiplied string of samples to produce a first antilogarithmed string of samples and said first antilogarithmed string of samples is directed to a first time integrator to produce said first loudness control signal, and a second antilogarithm is applied to said second multiplied string of samples to produce a second antilogarithmed string of samples and said second antilogarithmed string of samples is directed to a second time integrator to produce said second loudness control signal.

44. The method of claim 43 wherein said first time integrator sends said first loudness control signal in a first feedback path back to a first integrator summer, and said second time integrator sends said second loudness control signal in a second feedback path back to a second integrator summer.

45. The method of claim 44 wherein said first feedback path includes a first one-sample time delay which produces a first sample-delayed signal from said first loudness control signal, and said second feedback path includes a second one-sample time delay which produces a second sample-delayed signal from said second loudness control signal.

46. The method of claim 45 wherein said first sample-delayed signal is added to said first antilogarithmed string of samples at said first integrator summer to produce said first loudness control signal, and said second sample-delayed signal is added to said second antilogarithmed string of samples at said second integrator summer to produce said second loudness control signal.

47. The method of claim 43 wherein said first antilogarithmed string of samples is directed to said first time integrator via a first limiter which insures a first upper limit to input to said first integrator, and said second antilogarithmed string of samples is directed to said second time integrator via a second limiter which insures a second upper limit to input to said second integrator.

48. The method of claim 43 wherein said first loudness control signal is utilized to produce a first subtraction signal which is subtracted from said first logarithmed string of samples, and said second loudness control signal is utilized to produce a second subtraction signal which is subtracted from said second logarithmed string of samples.

49. The method of claim ZC5 wherein a first timing value is utilized in a subtraction at said first integrator summer, and a second timing value is utilized in a subtraction at said second integrator summer.

50. The method of claim 49 wherein a first logarithm of said first timing value is utilized in a first addition to said first logarithmed string of samples, and a second logarithm of said second timing value is utilized in a second addition to said second logarithmed string of samples.

51. The method of claim 50 wherein said first logarithm of said first timing value utilized in said first addition to said first logarithmed string of samples is divided by said first exponent value, and said second logarithm of said second timing value utilized in said second addition to said second logarithmed string of samples is divided by said second exponent value.

52. The method of claim 45 wherein said first feedback path further includes a first release override summer which subtracts a release override signal from said first sample-delayed signal to produce a first release override reduced signal, said first release override reduced signal being limited at a first max zero-versus-signal selector to produce a first positive-valued release override reduced signal, directing said first positive-valued release override reduced signal to a subtraction input of a second release-override summer where said first sample-delayed signal is input to an addition input of said second release override summer to produce a first release override reduced sample-delayed signal, and directing said first release override reduced sample-delayed signal to an addition input of said first integrator summer to produce said first loudness control signal, and wherein said second feedback path further includes a third release override summer which subtracts said release override signal from said second sample-delayed signal to produce a second release override reduced signal, said second release override reduced signal being limited at a second max zero-versus-signal selector to produce a second positive-valued release override reduced signal, directing said second positive-valued release override reduced signal to a subtraction input of a fourth release-override summer where said second sample-delayed signal is input to an addition input of said fourth release override summer to produce a second release override reduced sample-delayed signal, and directing said second release override reduced sample-delayed signal to an addition input of said second integrator summer to produce said second loudness control signal.

53. The method of claim 52 wherein said first positive-valued release override reduced signal is utilized in a first multiplication by said first timing value prior to input to said subtraction input of said second release-override summer, and said second positive-valued release override reduced signal is utilized in a second multiplication by said second timing value (1726) prior to input to said subtraction input of said fourth release-override summer.

54. The method of claim 53 wherein said release override signal is produced by taking logarithms of absolute values of said input string of said input samples to produce a third logarithmed string of samples, and directing said third logarithmed string of samples to a third time integrator which produces said release override signal.

55. The method of claim 54 wherein said third logarithmed string of samples is the same as said first logarithmed string of samples and said second logarithmed string of samples.

56. The method of claim 54 wherein said third time integrator sends said release override signal in a third feedback path back to a third integrator summer.

57. The method of claim 56 wherein said third feedback path includes a third one-sample time delay which produces a third sample-delayed signal.

58. The method of claim 57 wherein said third sample-delayed signal is added to a third addition signal derived from said third logarithmed string of samples at said third integrator summer to produce said release override signal.

59. The method of claim 58 wherein said third sample-delayed signal is subtracted from said third logarithmed string of samples to produce a value-reduced logarithmed string of samples which is utilized to produce said third addition signal.

60. The method of claim 59 wherein said value-reduced logarithmed string of samples is directed to said third time integrator via a third limiter to insure a third upper limit to said third addition signal.

61. The method of claim 59 wherein said value-reduced logarithmed string of samples is multiplied by a sample correction rate to produce a corrected value-reduced logarithmed string of samples which is directed to said third time integrator via a third limiter to insure a third upper limit to said third addition signal.
